(19) United States
(12) Patent Application Publication
(10) Pub. No.: US 2012/0124399 A1
(43) Pub. Date: May 17, 2012

(54) Method and System of Power Control

(76) Inventor: Yi-Ting Liao, New Taipei City (TW)

(21) Appl. No.: 13/115,119

(22) Filed: May 25, 2011

(30) Foreign Application Priority Data
Nov. 15, 2010 (TW) 099139167

(51) Int. Cl. G06F 1/26

(52) U.S. Cl. 713/310

(57) ABSTRACT

A power control method for a computer system is disclosed. The computer system establishes wireless connection with a handheld equipment via a wireless communication interface. The power control method includes receiving a sound signal transmitted from the handheld equipment via the wireless communication interface when the computer system operates in a shut-down state, recognizing the sound signal to generate a recognition result, and starting the computer system when the recognition result indicates that the sound signal conforms to a start command.

### BACKGROUND OF THE INVENTION

1. Field of the Invention

The present invention relates to a method and system of power control, and more particularly, to a method and system of power control for using a voice signal or particular sound effect to start a computer system via a handheld equipment.

2. Description of the Prior Art

Conventionally, starting a computer system is controlled by a power button. A user can start a computer system by pressing the power button. However, such an operation lacks flexibility, and cannot be integrated with a handheld electronic device, and thus needs improvement.

### SUMMARY OF THE INVENTION

Therefore, the present invention mainly provides a method and system of power control.

The present invention discloses a power control method for a computer system. The computer system establishes wireless connection with a handheld equipment via a wireless communication interface. The power control method comprises steps of receiving a sound signal transmitted from the handheld equipment via the wireless communication interface when the computer system operates at a shut-down state, recognizing the sound signal to generate a recognition result, and starting the computer system when the recognition result indicates that the sound signal conforms to a start command.

The present invention further discloses a power control system for a computer system, which comprises a handheld equipment, a power control device and a control unit. The handheld equipment comprises a microphone for receiving a sound signal, and a transmission unit, establishing wireless connection with the computer system via a wireless communication interface, for outputting the sound signal via the wireless communication interface. The power control device is installed in the computer system, and comprises a reception unit for receiving the sound signal transmitted from the transmission unit via the wireless communication interface when the computer system operates at a shut-down state, and a recognition unit for recognizing the sound signal received by the reception unit, to generate a recognition result. The control unit is utilized for starting the computer system when the recognition result indicates that the sound signal conforms to a start command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a power control system according to an embodiment of the present invention.

FIG. 2 is a function block diagram of a handheld equipment and power control device shown in FIG. 1.

FIG. 3 is a schematic diagram of a power control process according to an embodiment of the present invention.

### DETAILED DESCRIPTION

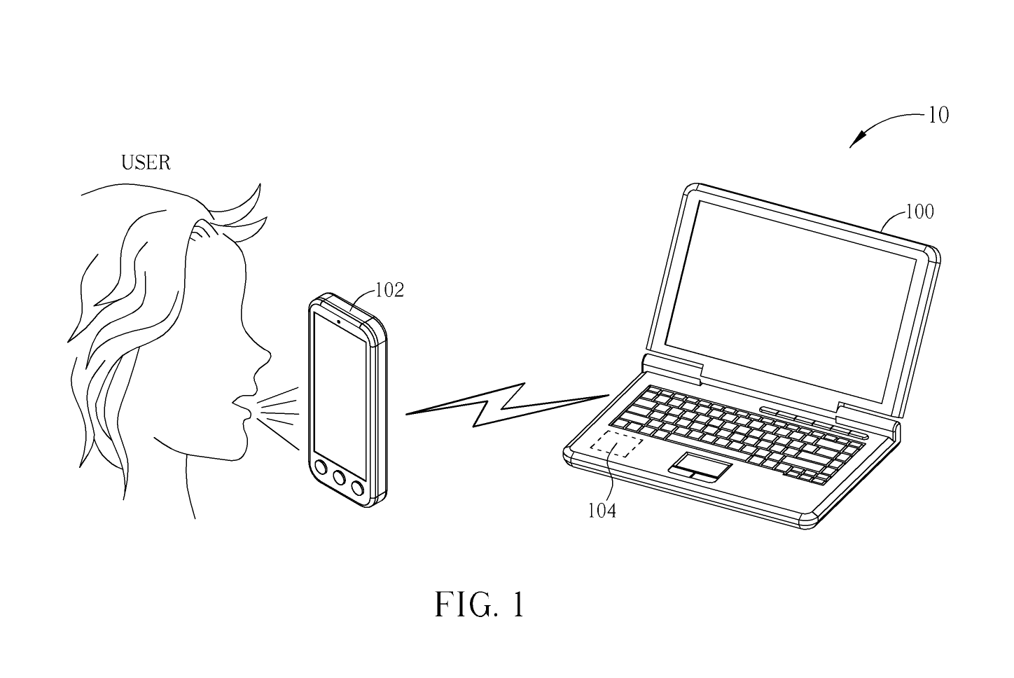

Please refer to FIG. 1, which is a schematic diagram of a power control system 10 according to an embodiment of the present invention. The power control system 10 is composed of a handheld equipment 102 and a power control device 104 installed in a computer system 100. The handheld equipment 102 is preferably a mobile phone, and supports short-distance wireless communication, such as a Bluetooth wireless communication interface. After the handheld equipment 102 and the computer system 100 establish wireless connection, if the computer system 100 operates in a shut-down state, a user USR can output a sound signal to the computer system 100 via the handheld equipment 102, such that the power control device 104 recognizes the sound signal from the user USR, to control start of the computer system 100.

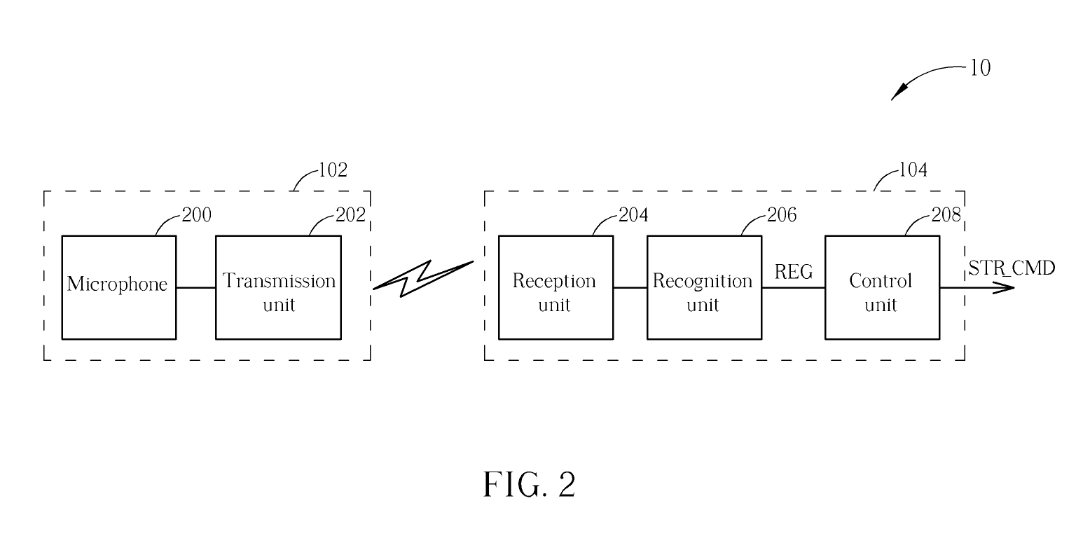

In detail, please continue to refer to FIG. 2, which is a functional block diagram of the handheld equipment 102 and the power control device 104 shown in FIG. 1. Note that, for simplicity, FIG. 2 only shows function blocks related to the invention idea of the present invention in the handheld equipment 102, and compositions of other function blocks can be adjusted or derived according to different systems. As shown in FIG. 2, the handheld equipment 102 includes a microphone 200 and a transmission unit 202. The microphone 200 receives the sound signal from the user USR, and the transmission unit 202 transmits the sound signal to the power control device 104 via a wireless communication interface. The power control device 104 includes a reception unit 204, a recognition unit 206 and a control unit 208. The reception unit 204 receives the sound signal outputted from the transmission unit 202, and transmits the sound signal to the recognition unit 206. The recognition unit 206 stores a start command which is a sound effect prerecorded by the user USR and utilized for starting the computer system 100. The sound effect can be a voice, e.g. “start”, a particular rhythm or frequency, such as clapping, etc. When the recognition unit 206 receives the sound signal transmitted from the reception unit 204, the recognition unit 206 compares the received sound signal and the stored start command, and generates a recognition result REG accordingly. Finally, when the recognition result REG indicates that the sound signal transmitted from the handheld equipment 102 matches the start command stored in the recognition unit 206, the control unit 208 outputs a start control signal STR_CMD, to start the computer system 100.

In short, with the power control system 10, the user USR can prerecord the sound effect for starting the computer system 100 in the recognition unit 206, and establish the wireless connection between the handheld equipment 102 and the computer system 100, such that when the computer system 100 operates in the shut-down state, the user USR can start the computer system 100 via the handheld equipment 102. Note that, the above description refers to the concept of the present invention, and detailed implementation should be adjusted according to different systems. For example, in order to ensure the power control device 104 functions properly, when the computer system 100 operates in a shut-down state, the computer system 100 can further provide operating power to the power control device 104. In addition, the wireless connection interface between the handheld equipment 102 and the computer system 100 is not limited to Bluetooth, and techniques of infrared rays, Wireless Local Area Network (WLAN), etc., can be used as well. However, no matter which wireless connection technique is adopted by the handheld equipment 102 and the computer system 100, the most important matter is that the transmission unit 202 and the reception unit 204 can match each other. Furthermore, a recognition method used by the recognition unit 206 is preferably achieved by using a Markov process, but is not limited hereinafter. The control unit 208 can be installed alone or integrated into a keyboard controller of the computer system 100.

In addition, in order to maintain information security, the handheld equipment 102 and the power control device 104 can further adopt complex encoding or encryption algorithms, i.e. adding an encoder or encryption unit between the microphone 200 and the transmission unit 202, and a corresponding decoder or decryption unit between the reception unit 204 and the recognition unit 206. Consequently, information security can be enhanced. Alternatively, information security can be enhanced by decreasing a tolerance of the recognition unit 206, i.e. the user USR has to more accurately pronounce a sound that matches the start command stored in the recognition unit 206 in order to start the computer system 100.

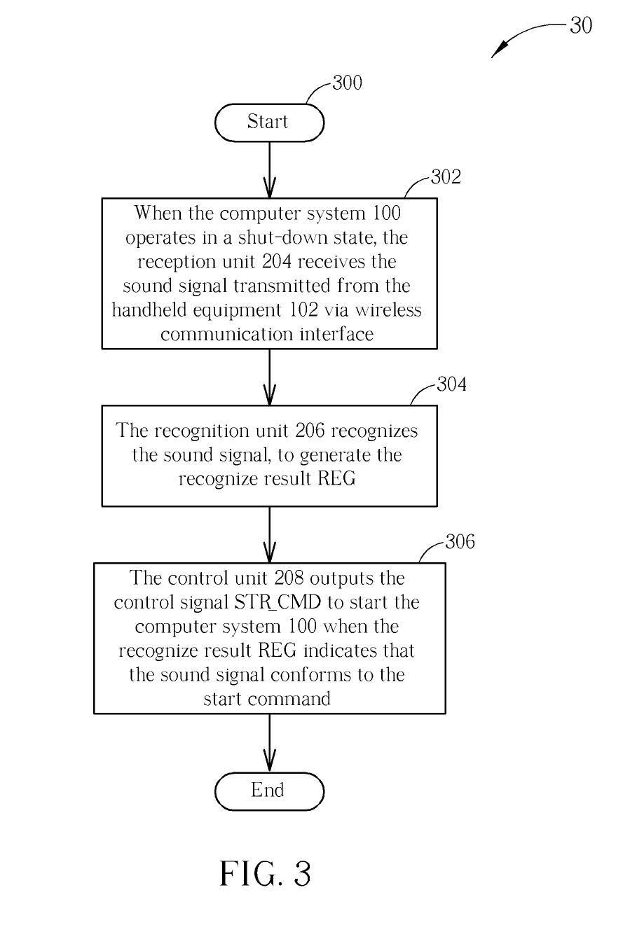

The above-mentioned operations of the power control device 104 can be further summarized into a power control process 30 as shown in FIG. 3. The power control process 30 includes the following steps:

Steps 300: Start.

Steps 302: When the computer system 100 operates in a shut-down state, the reception unit 204 receives the sound signal transmitted from the handheld equipment 102 via wireless communication interface.

Steps 304: The recognition unit 206 recognizes the sound signal, to generate the recognize result REG.

Steps 306: The control unit 208 outputs the control signal STR_CMD to start the computer system 100 when the recognize result REG indicates that the sound signal conforms to the start command.

Steps 308: End.

The power control process 30 refers to the operations of the power control device 104, and detailed descriptions can be referred above, not elaborated here.

In the prior art, starting of a computer system is controlled by a power button. However, the operation lacks of flexibility, and cannot be integrated with a handheld electronic device. In comparison, with the power control system 10 of the present invention, the user USR can send a default voice signal or a particular sound effect to the handheld equipment 102, to start the computer system 100. Therefore, the present invention can effectively enlighten operations of the computer system 100, and be able to be integrated with the handheld equipment 102.

To sum up, with the power control system according to the present invention, user can use a voice signal or a particular sound effect to start a computer system via a handheld equipment.

Those skilled in the art will readily observe that numerous modifications and alterations of the device and method may be made while retaining the teachings of the invention.

What is claimed is:

1. A power control method for a computer system, the computer system establishing wireless connection with a handheld equipment via a wireless communication interface, the power control method comprising:
receiving a sound signal transmitted from the handheld equipment via the wireless communication interface when the computer system operates at a shut-down state;
recognizing the sound signal to generate a recognition result; and
starting the computer system when the recognition result indicates that the sound signal conforms to a start command.

2. A power control system for a computer system, comprising:
a handheld equipment comprising:
a microphone, for receiving a sound signal; and
a transmission unit, establishing wireless connection with the computer system via a wireless communication interface, for outputting the sound signal via the wireless communication interface; and
a power control device, installed in the computer system, comprising:
a reception unit, for receiving the sound signal transmitted from the transmission unit via the wireless communication interface when the computer system operates at a shut-down state;
a recognition unit, for recognizing the sound signal received by the reception unit, to generate a recognition result; and
a control unit, for starting the computer system when the recognition result indicates that the sound signal conforms to a start command.
